(19) United States
(12) Patent Application Publication
(10) Pub. No.: US 2010/0183940 A1
(43) Pub. Date: Jul. 22, 2010

(54) FUEL CELL STACK

(75) Inventors: Sang-kyun KANG, Seoul (KR); Jung-seok YI, Seoul (KR); Jin-su HA, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/623,479

(22) Filed: Nov. 23, 2009

(30) Foreign Application Priority Data
Jan. 16, 2009 (KR) 10-2009-0003750

(51) Int. Cl. H01M 2/00; H01M 8/00

(52) U.S. Cl. 429/465; 429/467

(57) ABSTRACT

Provided is a fuel cell stack including stacked unit cells. Each unit cell includes a membrane-electrode assembly and a porous support.

### CROSS-REFERENCE TO RELATED APPLICATION

This application claims the benefit of Korean Application No. 10-2009-0003750, filed Jan. 16, 2009 in the Korean Intellectual Property Office, the disclosure of which is incorporated herein by reference.

### BACKGROUND

1. Field

One or more embodiments relate to a fuel cell stack, and more particularly, to a fuel cell stack including a plurality of stacked unit cells.

2. Description of the Related Art

In general, fuel cells consist of unit cells. Each unit cell includes a membrane-electrode assembly (MEA). The MEA includes an electrolyte membrane and catalyst layers disposed on electrodes, and a separator disposed between the electrodes. In a single unit cell, fuel (hydrogen) as an anode gas is supplied through a fuel gas flow path on an anode side of the separator, and an oxidant gas (air) as a cathode gas is supplied through an oxidant gas flow path on a cathode side of the separator. The supplied hydrogen and oxygen are respectively diffused into a diffusion layer close to the anode (“anode diffusion layer”) and a diffusion layer close to the cathode (“cathode diffusion layer”). Oxygen the cathode diffusion layer is reduced to oxygen ions upon contacting the cathode catalyst layer coated on the electrolyte membrane. Hydrogen ions produced by oxidation of hydrogen in the anode permeate through the electrolyte membrane to the cathode to combine with the oxygen ions and electrons transferred thereto via an external circuit to form water.

The voltage generated from each of the unit cells is theoretically only about 1.2V. Thus, multiple unit cells are stacked upon one another and electrically connected in series to generate a desired high voltage. In this case, an equal number of flow paths to the stacked unit cells and bipolar plates, constituting current collector plates, are applied in order to supply fuel and air to each of the unit cells and collect generated electricity.

However, in order to reduce the volume and weight of such stacked fuel cells and simplify the flow paths, a monopolar fuel cell structure has been used. The monopolar fuel cell structure includes a monopolar plate, instead of the bipolar plate, has been used.

### SUMMARY

One or more embodiments include a fuel cell stack having a novel structure.

To achieve the above and/or other aspects, one or more embodiments may include a fuel cell stack including first unit cells and second unit cells, which are alternately stacked upon one another, each of the first unit cells including a first cathode, a first anode, a first electrolyte membrane disposed between the first cathode and the first anode, and a first porous support formed on the first anode, and each of the second unit cells including a second anode formed on the first porous support, a second cathode, a second electrolyte membrane disposed between the second anode and the second cathode, and a second porous support formed on the second cathode, wherein the pore size of each of the first porous support and the second porous support increases from opposite surfaces thereof to the center thereof.

Each of the first porous support and the second porous support may include two microporous outer layers and a mesoporous intermediate layer disposed between the two microporous outer layers.

The first porous support may include a fuel inlet and a fuel outlet through which fuel is supplied to the first porous support to flow in a first direction parallel to the first anode and the second anode through pores and is supplied to the first anode and the second anode, and the second porous support may include an air inlet and an air outlet through which air is supplied to the second porous support to flow in a second direction parallel to the first cathode and the second cathode through pores and is supplied to the first cathode and the second cathode.

The first direction and the second direction may be perpendicular to each other.

The fuel cell stack may further include a fuel inlet manifold connecting a plurality of fuel inlets, a fuel outlet manifold connecting a plurality of fuel outlets, an air inlet manifold connecting a plurality of air inlets, and an air outlet manifold connecting a plurality of air outlets.

The first anode formed on an upper surface of the first porous support and the second anode formed on a lower surface of the first porous support may be electrically connected, and the first cathode formed on an upper surface of the second porous support and the second cathode formed on a lower surface of the second porous support may be electrically connected.

The fuel cell stack may further include: a first current collector disposed on a side or two opposite sides of the first porous support, and a second current collector disposed on a side or two opposite sides of the second porous support, wherein the first anode formed on the upper surface of the first porous support and the second anode formed on the lower surface of the first porous support may be electrically connected by the first current collector, and the first cathode formed on the upper surface of the second porous support and the second cathode formed on the lower surface of the second porous support may be electrically connected by the second current collector.

The first current collector and the second current collector may be disposed perpendicular to each other.

The first unit cells and the second unit cells may be electrically connected in parallel.

The microporous outer layers may include an electrically conductive material.

The mesoporous intermediate layer may include an electrically resistive material.

Each of the first electrolyte membrane and the second electrolyte membrane may include a proton-conducting solid oxide or an oxygen-ion conducting solid oxide.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic, partial sectional view of a fuel cell stack according to an embodiment;

FIG. 2 is a schematic view for describing the operating principle of a fuel cell stack according to an embodiment;

FIGS. 3A and 3B are schematic perspective views of structures of a first unit cell and a second unit cell of the fuel cell stack of FIG. 1, respectively; and

FIG. 4 is a schematic perspective view of the structure of a fuel cell stack according to another embodiment.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

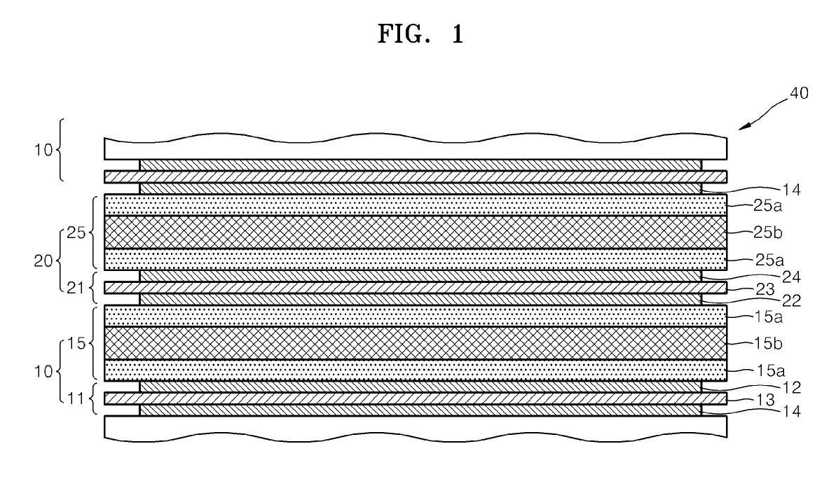

FIG. 1 is a schematic, partial sectional view of a fuel cell stack 40 according to an embodiment. Referring to FIG. 1, the fuel cell stack 40 has a structure in which first unit cells 10 and second unit cells 20 are alternately stacked upon one another. Referring to the lower part of FIG. 1, each of the first unit cells 10 includes a first membrane-electrode assembly (MEA) 11 and a first porous support 15. The first MEA 11 includes a first cathode 14, a first anode 12, and a first electrolyte membrane 13 disposed between the first cathode 14 and the first anode 12. The first anode 12 contacts a surface of the first porous support 15. Another surface of the first porous support 15 opposite to the first anode 12 contacts a second anode 22 of the second unit cell 20. The second anode 22 is part of a second MEA 21 along with a second electrolyte membrane 23 and a second cathode 24, which are sequentially disposed on the second anode 22. The second MEA 21 is part of the second unit cell 20 along with a second porous support 25, which contacts the second cathode 24. The second porous support 25 contacts the first cathode 14 of another first unit cell 10, which is stacked on the second porous support 25. The first unit cells 10 and the second unit cells 20 are alternately stacked upon one another in the manner described above, thereby constituting the fuel cell stack 40. The fuel cell stack 40 may further include a substrate (not shown) supporting the stacked first and second unit cells 10 and 20.

The first and second cathodes 14 and 24 and the first and second anodes 12 and 22 may be, but are not specifically limited to, any electrode commonly used in the field. For example, the first and second anodes 12 and 22 may include at least one metal selected from the group consisting of platinum (Pt), silver (Ag), gold (Au), rhodium (Rh), palladium (Pd), ruthenium (Ru), nickel (Ni), iron (Fe), cobalt (Co), titanium (Ti), copper (Cu), and any combinations thereof. Alternatively, the first and second anodes 12 and 22 may include a cermet of at least one metal selected from the above group and an ionic conducting ceramic material. The first and second cathodes 14 and 24 may include at least one metal selected from the group consisting of platinum (Pt), silver (Ag), gold (Au), rhodium (Rh), palladium (Pd), ruthenium (Ru), lanthanum-strontium-manganese (LTM), lanthanum-strontium-cobalt-iron (LSCF), lanthanum-manganese, oxides thereof, and any combinations thereof. These materials functioning as a catalyst may be used as they are or as a support catalyst supported on an appropriate support.

The first and second electrolyte membranes 13 and 23 may be any electrolyte membrane commonly used in fuel cells. For example, the first and second electrolyte membranes 13 and 23 may be formed of zirconia ceramics (ZrO₂), ceria (CeO₂), or lanthanum-strontium-gadolinium-magnesium (LSGM) oxide, which are oxygen ions-conducting solid oxides. These electrically conductive solid oxides contain an appropriate amount of a stabilizer, such as yttria (Y₂O₃), ceria (CeO₂), scandia (Sc₂O₃), gadolinium oxide (Gd₂O₃), or the like, which are used to improve thermal stability at high temperatures and conductivity. Specific examples of stabilizers may include yttria stabilized zirconia (YSZ), scandia stabilized zirconia (ScSZ), gadolinia doped ceria (GDC), and the like. Alternatively, the first and second electrolyte membranes 13 and 23 may be formed of proton-conducting solid oxides. For example, the first and second electrolyte membranes 13 and 23 may include at least one material selected from a parent perovskite group consisting of barium zirconate (BZ), barium cerate (BC), strontium zirconate (SZ) and strontium cerate (SC) that are doped with divalent or trivalent cations and any combinations thereof, an oxide such as tin phosphate (SnP₂O₇) doped with trivalent elements (Al, In, or the like), or an oxide such as zeolite.

The shown first and second supports 15 have pores. The sizes of the pores of each of the first and second porous supports 15 and 25 may increase from opposite surfaces thereof towards the centers thereof. The pores may have a thickness in a range of about 0.1 mm to about 1 mm. For example, referring to FIG. 1, the first porous support 15 includes two microporous outer layers 15a, and a mesoporous intermediate layer 15b disposed between the two microporous outer layers 15a. Similarly, the second porous support 25 includes two microporous outer layers 25a, and a mesoporous intermediate layer 25b disposed between the two microporous outer layers 25a.

The term “microporous” throughout the specification refers to a material having nano-sized micropores, for example, in a range of about 20 to about 2,000 nm. The term “mesoporous” throughout the specification refers to a material having micro-sized mesopores, for example, in a range of about 2 to about 500 μm.

The first and second porous supports 15 and 25 may be formed from metal powder by sintering. For example, mesoporous metal powder, which has a pore size as defined above, is mixed with a binder and molded into a structure. The resulting structure is coated with microporous metal powder and sintered to obtain a structure having a desired shape.

The microporous outer layers 15a and 25a, which have nano-sized micropores, are contacted with the first and second cathodes 14 and 24 and the first and second anodes 12 and 22 by external pressure and function as supports for the electrodes. The microporous outer layers 15a and 25a may have a thickness of about 100 nm to about 10 μm.

The microporous outer layers 15a and 25a may be formed of an electrically conductive material to function as current collectors. The electrically conductive material may be, but is not specifically limited to, a carbonaceous material, a conductive metal, or the like. The carbonaceous material may include at least one selected from the group consisting of carbon powder, graphite, carbon black, acetylene black, active carbon, carbon nanotubes, carbon nanofibers, carbon nanowires, carbon nanohorns, carbon nanorings, and fluorene (C60), and any combinations thereof. The conductive metal may be gold (Au), silver (Ag), aluminum (Al), nickel (Ni), copper (Cu), platinum (Pt), titanium (Ti), manganese (Mn), zinc (Zn), iron (Fe), tin (Sn), chromium (Cr), or an alloy thereof.

The mesoporous intermediate layers 15b and 25b have micro-sized pores and thus may facilitate the supply of air and fuel through the mesopores. The mesoporous intermediate layers 15b and 25b may have a thickness of about 0.1 mm to about 1 mm.

In addition, the mesoporous intermediate layers 15b and 25b may be formed of an insulating material to insulate the microporous outer layers 15a and 25a, which are formed of an electrically conductive material, and the first and second cathodes 14 and 24 and the first and second anodes 12 and 22 from the outside. The mesoporous intermediate layers 15b and 25b may be formed of an electrically resistive material, and thus function as a resistor and a heater. A fuel cell including such intermediate layers functioning as a heater may rapidly reach an initial temperature when operated. The electrically resistive material may be, for example, Nicrome, or the like.

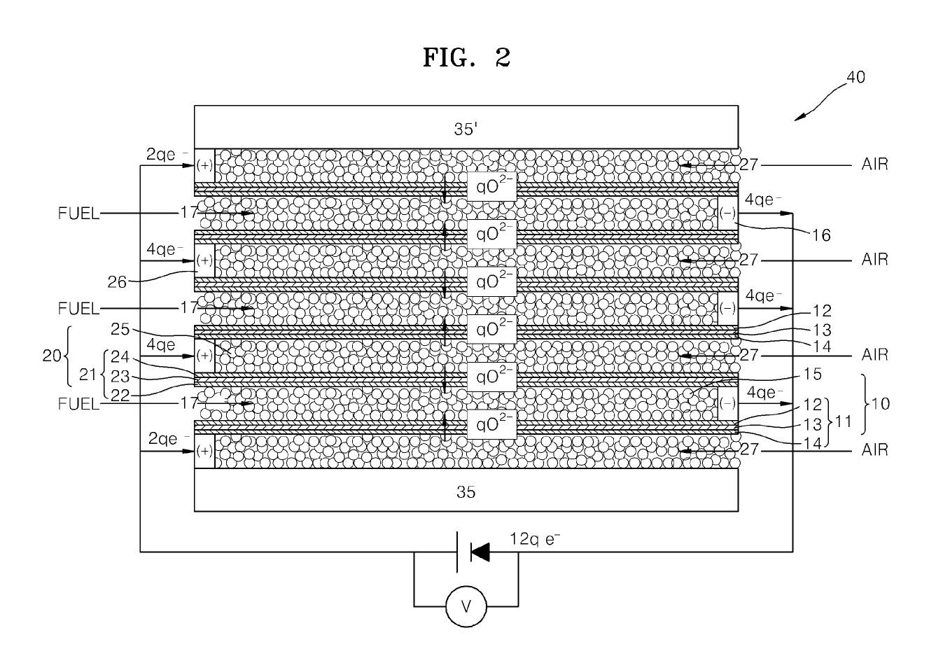

FIG. 2 is a schematic view for describing the operating principle of a fuel cell stack 40 according to an embodiment. Although in the current embodiment the operating principle of the fuel cell stack 40 is described with reference to a solid oxide fuel cell (SOFC) in which oxygen ions are transferred through the electrolyte membrane, embodiments are not limited to a specific fuel cell and may apply to various fuel cells. For example, the operating principle can be applied to a polymer electrolyte membrane fuel cell (PEMFC) in which protons are transferred through the electrolyte membrane.

When air, an oxidizer gas, is injected into the plurality of second porous supports 25 through a plurality of air inlets 27, the air moves in a direction parallel to the first and second cathodes 14 and 24, which contact the second porous supports 25. Thus, the air is supplied to the entire surface of each of the first and second cathodes 14 and 24. The air supplied to the first and second cathodes 14 and 24 reacts with electrons, which are influxed from the first and second anodes 12 and 22, in the presence of a catalyst to produce oxygen ions, as expressed in Reaction Scheme 1.

½qO₂+2qe⁻→qO²⁻ Reaction Scheme 1

In Reaction Scheme 1 above, q denotes the mole number of hydrogen involved in the reaction (see Reaction Scheme 2 below).

The oxygen ions generated in the first and second cathodes 14 and 24 are transferred to the first and second anodes 12 and 22 through the first and second electrolyte membranes 13 and 23, respectively, which contact the first and second anodes 12 and 22.

When hydrogen, a fuel gas, is injected into the plurality of first porous supports 15 through a plurality of fuel inlets 17, the hydrogen moves in a direction parallel to the first and second anodes 12 and 22, which contact the first porous supports 15, through the pores of the first porous supports 15. Thus, the hydrogen is supplied to the entire surface of each of the first and second anodes 12 and 22. The hydrogen supplied to the first and second anodes 12 and 22 react in the presence of a catalyst with the oxygen ions transferred through the first and second electrolyte membranes 13 and 23 from the first and second cathodes 14 and 24, thereby producing water and electrons. This reaction is expressed in Reaction Scheme 2 below.

qH₂+qO²⁻→qH₂O+2qe⁻ Reaction Scheme 2

The first and second anodes 12 and 22, which are adjacent to each other, may be electrically connected, as in the shown example, by a first current collector 16 that is disposed on a side of the first porous support 15. The electrons (2qe⁻) generated in the first anode 12 and the electrons (2qe⁻) generated in the second anode 22 adjacent to the first anode 12 are collected at the first current collector 16 and moves along an external circuit. The first and second cathodes 14 and 24, which are adjacent to each other, may be electrically connected, as in the shown example, by a second current collector 26 that is disposed on a side of the second porous support 25. The electrons (4qe⁻) collected at the second current collector 26 are separately transferred to the first and second cathodes 14 and 24.

As illustrated in the fuel cell stack 40 of FIG. 2, when three first anodes 12, three second anodes 22, three first cathodes 14, and three second cathodes 24 are stacked, 12qe⁻ electrons may flow through the entire fuel cell stack 40. The plurality of first anodes 12 and the plurality of second anodes 22 are electrically connected forming a single anode power line. The plurality of first cathodes 14 and the plurality of second cathodes 24 are electrically connected forming a single cathode power line. As a result, electrical power may be supplied. Due to this structure of the fuel cell stack 40, all the first unit cells 10 and the second unit cells 20 are electrically connected in parallel.

In general fuel cells, individual unit cells are connected in series. For the serial connection of unit cells, a bipolar plate is used to separate the fuel supplied to the anode of one unit cell from the air supplied to the cathode of another unit cell adjacent to the anode. However, the bipolar plate includes fuel flow paths on one surface, oxidizer flow paths on the opposite surface, and a separator plate separating the fuel and the oxidizer not to mix up, and thus the thickness of the fuel cell stack may be increased. Thus, a fuel cell including a bipolar plate may have a lower power density per unit volume.

Meanwhile, in the fuel cell stack 40 according to the current embodiment, the same type of electrodes are disposed on the opposite surfaces of the porous support 15, 25, and a single reactant, either fuel or air, flows through the porous support 15, 25. Thus, a separator plate is unnecessary. The porous support 15, 25 may be manufactured to have a thickness that is equivalent to, for example, one third of the thickness of a bipolar plate used in general fuel cell stacks. A fuel cell stack including such porous supports 15, 25 may have a thickness of about half or less the thickness of a general fuel cell stack including serially connected unit cells. Thus, the fuel cell 40 may provide a power density that is more than double that produced by a general fuel cell stack.

The smaller the size of individual unit cells of a fuel cell, the smaller the entire volume of the fuel cell system. In general, for fuel cells operating at temperatures of 100° C. or higher, insulation is necessary. The greater the power density per unit volume of a fuel cell stack, the further surface area of the fuel cell stack may be reduced. Then, a thermal loss decreases, and thus the volume occupied by the insulation decreases. Thus, the entire volume of a system including the full cell stack 40 may be reduced.

In addition, as the volume of a unit cell decreases, the yield of the fuel cell stack 40 may rise. In general, for a fuel cell stack including stacked unit cells, it is known that a failure probability of each unit cell increases as the size of the unit cell increases. In other words, an increase in area or volume of the unit cell adversely affects the yield of fuel cell stacks. The fuel cell stack 40 according to the current embodiment has smaller unit cells, however, may produce the same power as general fuel cell stacks, and thus may be manufactured in a higher yield.

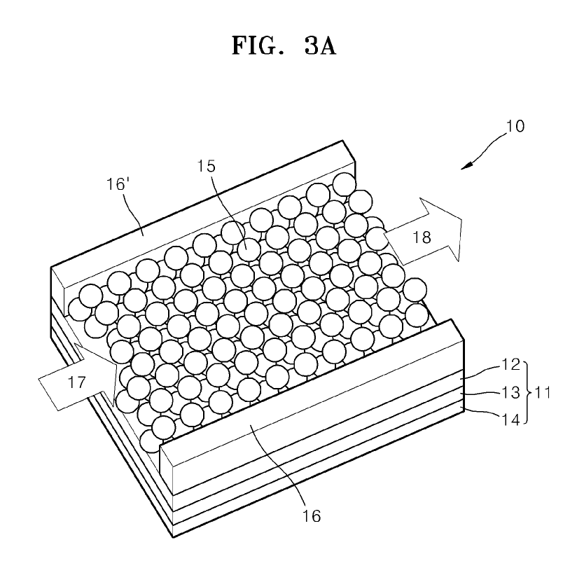

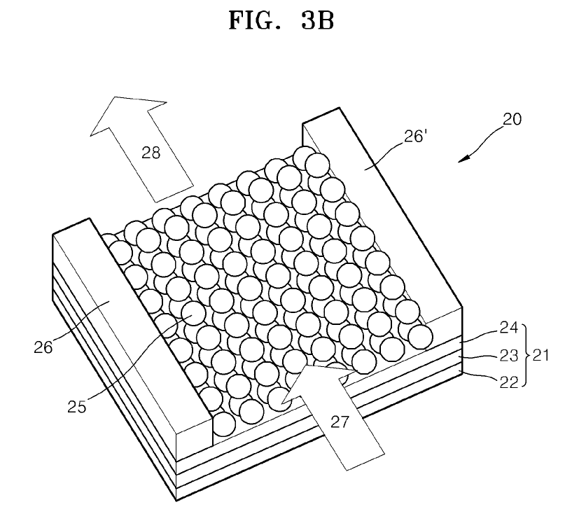

FIGS. 3A and 3B are schematic perspective views of examples of structures of the first unit cell 10 and the second unit cell 20 of the fuel cell stack 40 of FIGS. 1 and 2, respectively. Referring to FIG. 3A, the first porous support 15 is formed on the MEA 11. The MEA 11 includes the first cathode 14, the first electrolyte membrane 13, and the first anode 12. A number of pores are arranged in the first porous support 15 in a direction parallel to the first anode 12 and the second anode 22 (not shown), forming fuel flow paths. While fuel supplied through the fuel inlet 17 moves along the fuel flow paths towards the fuel outlet 18, the fuel is supplied to the first anode 12 and the second anode 22 (not shown). The first current collector 16 is disposed on a side of the first porous support 15 in a direction parallel to the fuel flow paths. While not required in all aspects, a first guide 16′, which guides the flow of fuel to be parallel to the first current collector 16, is disposed on a side of the first porous support 15 that is opposite to the first current collector 16. The first guide 16′ may function also as a current collector or may simply guide the flow.

Referring to FIG. 3B, the second porous support 25 is formed on the MEA 21. The MEA 21 includes the second anode 22, the second electrolyte membrane 23, and the second cathode 24. A number of pores are arranged in the second porous support 25 in a direction parallel to the second cathode 24 and the first cathode 14 (not shown), forming air flow paths. While air supplied through the air inlet 27 moves along the air flow paths towards the air outlet 28, the air is supplied to the second cathode 24 and the first cathode 14 (not shown). The second current collector 26 is disposed on a side of the second porous support 25 in a direction parallel to the air flow paths. While not required in all aspects, a second guide 26′, which guides the flow of air to be parallel to the second current collector 26, is disposed on a side of the second porous support 25 that is opposite to the second current collector 26. The second guide 26′ may function also as a current collector or may simply guide the flow.

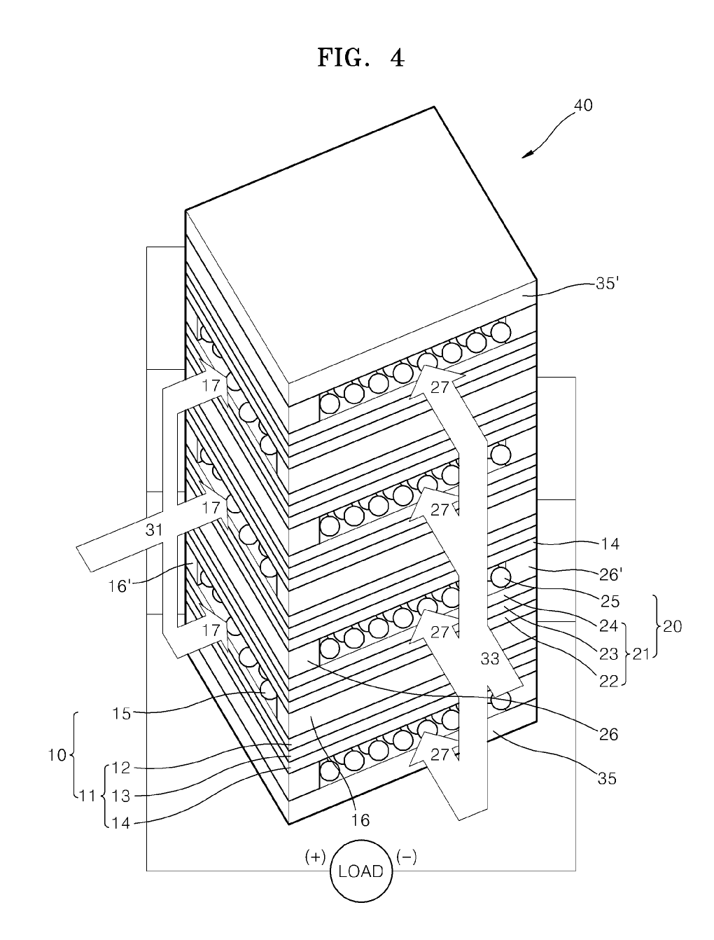

FIG. 4 is a schematic perspective view of a fuel cell stack 40 according to another embodiment, in which the first unit cells 10 and the second unit cells 20 described above are alternately stacked upon one another. Referring to FIG. 4, in the fuel cell stack 40, the first anode 12 of the first unit cell 10 and the second anode 22 of the second unit cell 20 are respectively disposed on opposite surfaces of the first porous support 15 to face each other. In addition, the second cathode 24 of the second unit cell 20 and the first cathode 14 of another first unit cell are respectively disposed on opposite surfaces of the second porous support 25 to face each other. Similar to the fuel cell stack of FIG. 2, the fuel cell stack 40 of FIG. 4 may further include substrates 35 and 35′, which support the stacked first and second unit cells 10 and 20.

Fuel and air may be supplied in directions perpendicular to each other. For example, the first unit cells 10 and the second unit cells 20 are stacked upon one another to form a hexahedral fuel cell stack, a plurality of fuel inlets 17 for supplying fuel and a plurality of air inlets 27 for supplying air may be respectively disposed on adjacent sides of the hexahedral fuel cell stack. In addition, a plurality of fuel outlets (not shown) may be disposed on a side of the fuel cell stack 40 opposite to the side on which the plurality of fuel inlets 17 are disposed. A plurality of air outlets (not shown) may be disposed on a side of the fuel cell stack 40 opposite to the side on which the plurality of air inlets 27 are disposed. The plurality of fuel inlets 17 are connected by a fuel inlet manifold 31, and the plurality of fuel outlets (not shown) are connected by a fuel outlet manifold (not shown). Meanwhile, the plurality of air inlets 27 are connected by an air inlet manifold 33, and the plurality of air outlets (not shown) are connected by an air outlet manifold (not shown). Thus, fuel is supplied to every fuel cell through a single fuel inlet manifold, and air is supplied to every fuel cell through a single air inlet manifold. This is a simple and effective design for fuel and air supply devices.

The first and second porous supports 15 and 25 are manufactured to support the first and second MEAs 11 and 21, respectively, and at the same time to be strong enough to be stably bound with other adjacent first and second MEAs 11 and 21, and thus maintain the shape of the fuel cell stack 40 to be constant.

Similar to the fuel cell stack 40 described with reference to FIG. 2, in the fuel cell stack 40 of FIG. 4, the first anode 12 and the second anode 22, which are disposed to face each other with the first porous support 15 therebetween, contact the first current collector 16 and the first guide 16′. The plurality of first current collectors 16 are electrically connected in parallel. Similarly, the second cathode 24 and the first cathode 14, which are disposed to face each other with the second porous support 25 therebetween, contact the second current collector 26 and the second guide 26′. The plurality of second current collectors 26 are electrically connected in parallel. While shown as perpendicular in FIG. 4, the fuel cell stack 40 can be manufactured with non parallel and non perpendicular flow directions, and thus the flows can be at other relative angles.

As described above, according to the one or more of the above embodiments, a fuel cell stack is formed by stacking smaller unit cells upon one another. In general, if the number of unit cells to be stacked is increased in order to manufacture a high-capacity fuel cell, more unit cells are likely to be defective in the fuel cell stack. For a general fuel cell including unit cells connected in series, if the performance of even a single unit cell deteriorates, the performance of the entire fuel cell system may deteriorate since a bottleneck may result from the defective unit cell.

However, according to the one or more of the above embodiments, since a plurality of small unit cells are connected in parallel, unit cells having poor performance do not affect the operation of other unit cells. Thus, the reliability of a fuel cell stack including such unit cells is improved compared to a fuel cell including large, stacked MEAs or a fuel cell stack including a plurality of unit cells connected in series. In addition, as such fuel cell stacks are formed by stacking several to tens of MEAs upon one another, a performance variation between fuel cell stacks is reduced according to the Central Limit Theorem.

The fuel cell stack according to the one or more of the above embodiments is applicable to polymer electrolyte membrane fuel cells (PEMFC), direct methanol fuel cells (DMFC), phosphoric acid fuel cells (PAFC), alkali fuel cells (AFC), molten carbonate fuel cells (MCFC), solid oxide fuel cells (SOFC), proton-conducting solid oxide solid fuel cells, and the like. The fuel cell stack may be used a SOFC, which operates at high temperatures and may increase activity of catalysts. In addition, when an electrolyte membrane not allowing crossover of water is used, an additional device for controlling water mass balance is not used. Thus, the fuel cell system has a much higher power density per unit volume.

Although a few embodiments of the present invention have been shown and described, it would be appreciated by those skilled in the art that changes may be made in this embodiment without departing from the principles and spirit of the invention, the scope of which is defined in the claims and their equivalents.

1. A fuel cell stack comprising:
a first unit cell comprising a first cathode, a first anode, a first electrolyte membrane disposed between the first cathode and the first anode, and a first porous support formed on the first anode; and
a second unit cell comprising a second anode formed on the first porous support such that the first porous support is between the first and second anodes, a second cathode, a second electrolyte membrane disposed between the second anode and the second cathode, and a second porous support formed on the second cathode,
wherein:
the first porous supports comprise pores with pore sizes which increase from opposite surfaces thereof to a center thereof, and
the second porous support comprises pores with pore sizes which increase from opposite surfaces thereof to a center thereof.

2. The fuel cell stack of claim 1, wherein each of the first and second porous supports comprises two microporous outer layers at the opposite surfaces and a mesoporous intermediate layer disposed between the two microporous outer layers and including the center.

3. The fuel cell stack of claim 1, wherein:
the first porous support comprises a fuel inlet and a fuel outlet through which fuel is supplied to the first porous support to flow in a first direction parallel to the first anode and the second anode through pores and is supplied to the first anode and the second anode, and
the second porous support comprises an air inlet and an air outlet through which air is supplied to the second porous support to flow in a second direction parallel to the first cathode and the second cathode through pores and is supplied to the first cathode and the second cathode.

4. The fuel cell stack of claim 3, wherein the first direction and the second direction are perpendicular to each other.

5. The fuel cell stack of claim 3, wherein the fuel cell stack comprises a plurality of the first and second unit cells, and the fuel cell stack further comprises a fuel inlet manifold connecting the fuel inlets, a fuel outlet manifold connecting the fuel outlets, an air inlet manifold connecting the air inlets, and an air outlet manifold connecting the air outlets.

6. The fuel cell stack of claim 1, wherein:
the first anode formed on an upper surface of the first porous support and the second anode formed on a lower surface of the first porous support are electrically connected, and
the fuel cell stack further comprises a third unit cell comprising a third cathode formed on the second porous support such that the second porous support is between the third and second cathodes, a third anode, and a third electrolyte membrane is disposed between the third anode and the third cathode,
the third cathode formed on an upper surface of the second porous support and the second cathode formed on a lower surface of the second porous support are electrically connected.

7. The fuel cell stack of claim 6, wherein
a first current collector is disposed on one or both of opposite sides of the first porous support,
a second current collector is disposed on one or both of opposite sides of the second porous support,
the first anode formed on the upper surface of the first porous support and the second anode formed on the lower surface of the first porous support are electrically connected by the first current collector, and
the third cathode formed on the upper surface of the second porous support and the second cathode formed on the lower surface of the second porous support are electrically connected by the second current collector.

8. The fuel cell stack of claim 7, wherein the first current collector and the second current collector are disposed perpendicular to each other.

9. The fuel cell stack of claim 7, wherein:
the first porous support comprises a fuel inlet and a fuel outlet through which fuel is supplied to the first porous support to flow in a first direction parallel to the first current collector through pores and is supplied to the first anode and the second anode, and
the second porous support comprises an air inlet and an air outlet through which air is supplied to the second porous support to flow in a second direction parallel to the second current collector through pores and is supplied to the first cathode and the second cathode.

10. The fuel cell stack of claim 1, wherein the first and second unit cells are electrically connected in parallel.

11. The fuel cell stack of claim 2, wherein each of the microporous outer layers comprise an electrically conductive material.

12. The fuel cell stack of claim 2, wherein each of the mesoporous intermediate layers comprise an electrically resistive material.

13. The fuel cell stack of claim 1, wherein each of the first electrolyte membranes and the second electrolyte membranes comprises a proton-conducting solid oxide or an oxygen-ion conducting solid oxide.
